(19) United States
(12) Patent Application Publication
(10) Pub. No.: US 2026/0217592 A1
(43) Pub. Date: Jul. 30, 2026

(54) GLASS AND METHOD FOR MANUFACTURING GLASS

(71) Applicant: AGC Inc., Tokyo (JP)

(72) Inventors: Naoki KANNO, Tokyo (JP); Koji SHIMIZU, Tokyo (JP)

(73) Assignee: AGC Inc., Tokyo (JP)

(21) Appl. No.: 19/630,455

(22) Filed: Mar. 27, 2026

Related U.S. Application Data
(63) Continuation of application No. PCT/JP2024/034245, filed on Sep. 25, 2024.

(30) Foreign Application Priority Data
Sep. 28, 2023 (JP) 2023-168687

(51) Int. Cl. C03C 3/068; C03C 3/066; G02B 27/00; G02B 27/01

(52) U.S. Cl. CPC C03C 3/068; C03C 3/066; G02B 27/0018; G02B 27/0172; C03C 2201/10; C03C 2201/28; C03C 2201/3411; C03C 2201/3417; C03C 2201/42; C03C 2203/20; G02B 2027/013

(57) ABSTRACT

Deposition of defects is suppressed while a high refractive index and a high transmittance are achieved. A glass (10) contains La₂O₃ and B₂O₃, has a refractive index n_{d} of 2.0100 or more, has a total content of Bi₂O₃ and B₂O₃ of less than 80% in terms of oxide-based mol %, has a total content of Pt and Fe of 0.5 ppm or more and 15.0 ppm or less in terms of a mass ratio, and has a parameter A defined by the formula (1) of 0.870 or more.

### CROSS-REFERENCE TO RELATED APPLICATION(S)

This application is a continuation of International Application No. PCT/JP2024/034245, filed on Sep. 25, 2024 which claims the benefit of priority of the prior Japanese Patent Application No. 2023-168687, filed on Sep. 28, 2023, the entire contents of which are incorporated herein by reference.

### BACKGROUND OF THE INVENTION

### 1. Field of the Invention

The present invention relates to glass and a method for manufacturing glass.

### 2. Description of the Related Art

In recent years, a glass having a high refractive index has been required. In particular, for example, in a wearable device such as a head mounted display that implements augmented reality (AR), virtual reality (VR), mixed reality (MR), and the like, a high refractive index with respect to visible light is required as a light guide plate. For example, WO 2018/235725 A describes an optical glass having a refractive index of 1.64 or more and 1.85 or less.

However, a glass having a high refractive index tends to have a low transmittance. In addition, a glass having a high refractive index tends to have a high possibility that impurities and the like are deposited as defects. Therefore, it is required to suppress deposition of defects while achieving a high refractive index and a high transmittance.

### SUMMARY OF THE INVENTION

It is an object of the present invention to at least partially solve the problems in the conventional technology.

The glass of the present disclosure comprises La₂O₃ and B₂O₃, having a refractive index n_{d} of 2.0100 or more, having a total content of Bi₂O₃ and B₂O₃ of less than 80% in terms of oxide-based mol %, having a total content of Pt and Fe of 0.5 ppm or more and 15.0 ppm or less in terms of a mass ratio, and having a parameter A defined by formula (1) of 0.870 or more.

$$A = {τ}_{440} + 0.005 \times ( Pt + Fe ) \qquad ( 1 )$$

The method for manufacturing a glass comprises; heating raw materials at 950° C. or higher and 1600° C. or lower to dissolve the raw materials; and cooling the dissolved raw materials to obtain the glass.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view of a glass according to the present embodiment; and

FIG. 2 is a cross-sectional view when the glass according to the present embodiment is a glass plate.

### DETAILED DESCRIPTION OF THE PREFERRED EMBODIMENTS

Hereinafter, a preferred embodiment of the present invention will be described in detail with reference to the attached drawings. Note that the present invention is not limited by the embodiment, and when there is a plurality of embodiments, the present invention includes a combination of the embodiments. A numerical value includes a range of rounding. In addition, a numerical range represented by “to” means a numerical range including numerical values before and after “to” as a lower limit value and an upper limit value, and when “to” is used in the following description, a similar meaning is given. In the present embodiment, a lower limit value and an upper limit value can be appropriately combined.

### Glass

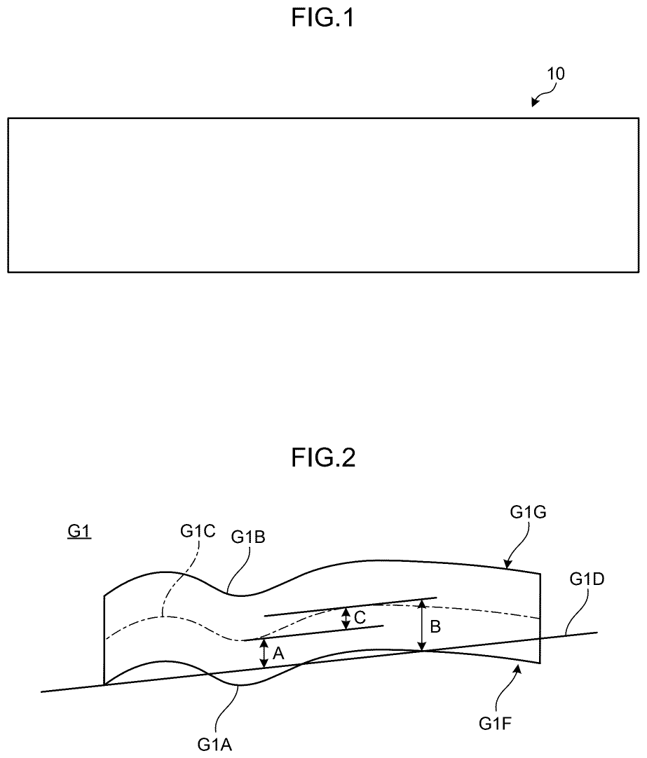

FIG. 1 is a schematic view of a glass according to the present embodiment. As illustrated in FIG. 1, a glass 10 according to the present embodiment is a plate-like glass plate, but the shape of the glass 10 is not limited to the plate shape and may be any shape. In the present embodiment, the glass 10 is used as a light guide plate. More specifically, the glass 10 is used as a light guide plate for a head mounted display. The head mounted display is a display device (wearable device) worn on a human head. Note that the glass 10 may be used for any use, and is not limited to being used as a light guide plate, and is not limited to being used for a head mounted display.

### Refractive Index n_{d}

A refractive index n_{d} of the glass 10 is 2.0100 or more, preferably 2.0150 or more, more preferably 2.0200 or more, still more preferably 2.0250 or more, further still more preferably 2.0300 or more, further still more preferably 2.0350 or more, and further still more preferably 2.0400 or more. In addition, the refractive index n_{d} of the glass 10 is preferably 2.2000 or less, more preferably 2.1800 or less, still more preferably 2.1600 or less, further still more preferably 2.1400 or less, further still more preferably 2.1200 or less, further still more preferably 2.1100 or less, and further still more preferably 2.0600 or less. In addition, the refractive index n_{d} of the glass 10 is preferably 2.0150 or more and 2.2000 or less, more preferably 2.0200 or more and 2.1800 or less, still more preferably 2.0250 or more and 2.1600 or less, further still more preferably 2.0300 or more and 2.1400 or less, further still more preferably 2.0350 or more and 2.1200 or less, and further still more preferably 2.0400 or more and 2.0600 or less. When the refractive index n_{d} falls within this range, the refractive index is high with respect to visible light, and appropriate optical characteristics can be imparted to the glass 10.

Note that the refractive index n_{d} refers to a refractive index at a d-line (wavelength 587.6 nm) of helium. The refractive index n_{d} can be measured by a V block method.

### Parameter A

A parameter A of the glass 10 is expressed by the following formula (1).

$$A = {τ}_{440} + 0.005 \times ( Pt + Fe ) \qquad ( 1 )$$

τ₄₄₀ in the formula (1) is an internal transmittance with respect to light having a wavelength of 440 nm when the thickness is converted to 10 mm. In addition, (Pt+Fe) is a ratio (ppm) of the total content of Pt and Fe to the entire glass 10 in terms of a mass ratio.

The parameter A defined by the formula (1) is a value of 0.870 or more. The parameter A is preferably 0.880 or more, more preferably 0.890 or more, still more preferably 0.900 or more, further still more preferably 0.910 or more, further still more preferably 0.920 or more, and further still more preferably 0.930 or more, whereby both the internal transmittance of the glass and appropriate manufacturing conditions are achieved, which is preferable.

When the parameter A that defines the relationship between the total content of Pt and Fe and the transmittance falls within the above range, the glass 10 can maintain a high transmittance with respect to visible light even when Pt and Fe are contained.

Note that the internal transmittance is a transmittance that passes through the glass 10. The internal transmittance can be obtained from measured values of two types of external transmittances having different plate thicknesses and the following formula (A). Note that the external transmittance means a transmittance including a surface reflection loss. In the formula (A), τ is an internal transmittance of the glass when the thickness is converted to 10 mm, T1 and T2 are external transmittances, and Δd is a difference in thickness between samples. The external transmittance can be measured using a spectrophotometer (U-4100 manufactured by Hitachi High-Technologies Corporation) for a sample whose both surfaces have been mirror-polished so as to have a plate thickness of 10 mm.

$$log τ = - \frac{log T 1 - log T 2}{Δ d} \times 10 \qquad ( A )$$

In addition, Pt and Fe here do not refer to only elemental metals of Pt and Fe contained in the glass 10, and may include elemental metals of Pt and Fe and compounds thereof. That is, it can be said that the total content of Pt and Fe includes the content of elemental metals of Pt and Fe and the content of ions of Pt and Fe in compounds thereof.

The contents of Pt and Fe can be measured by ICP mass spectrometry. As a measuring instrument, for example, Agilent 8800 manufactured by Agilent Technologies can be used. Measurement was performed by the following procedure.

When the content is measured, a mixed acid of hydrofluoric acid and sulfuric acid is added to the pulverized glass 10, and the mixture is heated to decompose the glass 10. After the decomposition, hydrochloric acid is added to the mixture so as to reach a certain amount, and the concentration of a measurement element is measured by ICP mass spectrometry. The concentration is calculated from a calibration curve prepared using a standard solution. The concentration of the measurement element in the glass 10 can be calculated from the measured concentration and the decomposition amount of the glass 10. The following elements can also be measured by a similar procedure.

### Parameter B

A parameter B of the glass 10 is expressed by the following formula (2).

$$B = {τ}_{440} + 0.583 \times {n}_{d} \qquad ( 2 )$$

Here, τ₄₆₀ is an internal transmittance with respect to light having a wavelength of 460 nm when the thickness is converted to 10 mm, and n_{d} is a refractive index n_{d} of the glass 10.

The parameter B in the formula (2) is a value of 2.075 or more. The parameter B is preferably 2.080 or more, more preferably 2.090 or more, still more preferably 2.100 or more, further still more preferably 2.105 or more, further still more preferably 2.112 or more, further still more preferably 2.115 or more, further still more preferably 2.117 or more, further still more preferably 2.118 or more, further still more preferably 2.124 or more, further still more preferably 2.127 or more, and further still more preferably 2.130 or more, whereby a clear image with a high viewing angle is obtained, which is preferable.

When the parameter B indicating the relationship between the refractive index and the transmittance falls within the above range, the glass 10 can maintain a high transmittance with respect to visible light even with a high refractive index.

### Composition

Hereinafter, the composition of the glass 10 will be described.

La₂O₃ and B₂O₃

The glass 10 contains La₂O₃ and B₂O₃. By containing La₂O₃ and B₂O₃, the glass 10 can appropriately achieve a high refractive index and a high transmittance.

Whether or not the glass 10 contains La₂O₃ and B₂O₃ can be measured by ICP mass spectrometry. As a measuring instrument, for example, Agilent 8800 manufactured by Agilent Technologies can be used.

### Pt and Fe

In the glass 10, the total content of Pt and Fe with respect to the entire glass 10 in terms of a mass ratio is 0.5 ppm or more and 15.0 ppm or less, preferably 1.0 ppm or more, more preferably 2.0 ppm or more, still more preferably 3.0 ppm or more, further still more preferably 4.0 ppm or more, further still more preferably 5.0 ppm or more, and further still more preferably 6.0 ppm or more. In the glass 10, the total content of Pt and Fe with respect to the entire glass 10 in terms of a mass ratio is preferably 14.0 ppm or less, more preferably 13.0 ppm or less, still more preferably 12.0 ppm or less, further still more preferably 11.0 ppm or less, further still more preferably 10.0 ppm or less, and further still more preferably 9.0 ppm or less. In the glass 10, the total content of Pt and Fe with respect to the entire glass 10 in terms of a mass ratio is preferably 1.0 ppm or more and 14.0 ppm or less, more preferably 2.0 ppm or more and 13.0 ppm or less, still more preferably 3.0 ppm or more and 12.0 ppm or less, further still more preferably 4.0 ppm or more and 11.0 ppm or less, further still more preferably 5.0 ppm or more and 10.0 ppm or less, and further still more preferably 6.0 ppm or more and 9.0 ppm or less. When an upper limit of Pt and Fe falls within this range, deposition of Pt and Fe as defects can be suppressed. In addition, when a lower limit of Pt and Fe falls within this range, it is possible to allow a material containing Pt and Fe to be used as a raw material or equipment such as a crucible at the time of manufacturing, and the manufacturing can be appropriately performed.

Bi₂O₃ and B₂O₃

In the glass 10, the total content of Bi₂O₃ and B₂O₃ in terms of oxide-based mol % is less than 80.0%, preferably 75.0% or less, more preferably 70.0% or less, still more preferably 65.0% or less, further still more preferably 60.0% or less, further still more preferably 55.0% or less, further still more preferably 50.0% or less, and further still more preferably 45.0% or less. In the glass 10, the total content of Bi₂O₃ and B₂O₃ in terms of oxide-based mol % is preferably 0% or more, more preferably 1.5% or more, still more preferably 5.0% or more, further still more preferably 10.0% or more, further still more preferably 15.0% or more, further still more preferably 20.0% or more, and further still more preferably 25.0% or more. In the glass 10, the total content of Bi₂O₃ and B₂O₃ in terms of oxide-based mol % is preferably 0% or more and 75.0% or less, more preferably 1.5% or more and 70.0% or less, still more preferably 5.0% or more and 65.0% or less, further still more preferably 10.0% or more and 60.0% or less, further still more preferably 15.0% or more and 55.0% or less, further still more preferably 20.0% or more and 50.0% or less, and further still more preferably 25.0% or more and 45.0% or less. When the total content of Bi₂O₃ and B₂O₃ falls within this range, a high refractive index and a high transmittance can be appropriately achieved.

### Preferred Composition

Hereinafter, a preferred composition of the glass 10 will be described in detail.

### SiO₂

The glass 10 preferably contains SiO₂. In the glass 10, the content of SiO₂ in terms of oxide-based mol % is preferably 0% or more, more preferably 1.0% or more, still more preferably 2.0% or more, further still more preferably 3.0% or more, further still more preferably 4.0% or more, further still more preferably 5.0% or more, further still more preferably 6.0% or more, and further still more preferably 7.0% or more. In the glass 10, the content of SiO₂ in terms of oxide-based mol % is preferably 20.0% or less, more preferably 19.0% or less, still more preferably 18.0% or less, further still more preferably 17.0% or less, further still more preferably 16.0% or less, further still more preferably 15.0% or less, further still more preferably 14.0% or less, further still more preferably 13.0% or less, and further still more preferably 10.0% or less. In the glass 10, the content of SiO₂ in terms of oxide-based mol % is preferably 0% or more and 20.0% or less, more preferably 1.0% or more and 19.0% or less, still more preferably 2.0% or more and 18.0% or less, further still more preferably 3.0% or more and 17.0% or less, further still more preferably 4.0% or more and 16.0% or less, further still more preferably 5.0% or more and 15.0% or less, further still more preferably 6.0% or more and 14.0% or less, further still more preferably 7.0% or more and 13.0% or less, and further still more preferably 7.0% or more and 10.0% or less. When the content of SiO₂ falls within this range, coloring of the glass is reduced to increase a transmittance with respect to short-wavelength visible light, and stable glass formation is promoted to improve devitrification resistance of the glass.

B₂O₃

The glass 10 preferably contains B₂O₃. In the glass 10, the content of B₂O₃ in terms of oxide-based mol % is preferably 0% or more, more preferably 1.5% or more, still more preferably 3.5% or more, further still more preferably 5.0% or more, further still more preferably 7.5% or more, further still more preferably 10.0% or more, further still more preferably 12.0% or more, further still more preferably 13.0% or more, further still more preferably 14.0% or more, further still more preferably 15.0% or more, and further still more preferably 16.0% or more. In the glass 10, the content of B₂O₃ in terms of oxide-based mol % is preferably 30.0% or less, more preferably 28.0% or less, still more preferably 26.0% or less, further still more preferably 24.0% or less, further still more preferably 22.0% or less, further still more preferably 21.0% or less, further still more preferably 20.0% or less, and further still more preferably 19.5% or less. In the glass 10, the content of B₂O₃ in terms of oxide-based mol % is preferably 0% or more and 30.0% or less, more preferably 1.5% or more and 28.0% or less, still more preferably 3.5% or more and 26.0% or less, further still more preferably 5.0% or more and 24.0% or less, further still more preferably 7.5% or more and 22.0% or less, further still more preferably 10% or more and 21.0% or less, further still more preferably 12% or more and 20.0% or less, further still more preferably 14% or more and 20.0% or less, and further still more preferably 16% or more and 19.5% or less. When the content of B₂O₃ falls within this range, coloring of the glass is reduced to increase a transmittance with respect to short-wavelength visible light, and stable glass formation is promoted to improve devitrification resistance of the glass.

Y₂O₃

The glass 10 preferably contains Y₂O₃. In the glass 10, the content of Y₂O₃ in terms of oxide-based mol % is preferably 0% or more, more preferably 0.5% or more, still more preferably 1.0% or more, further still more preferably 1.5% or more, further still more preferably 2.0% or more, and further still more preferably 2.5% or more. In the glass 10, the content of Y₂O₃ in terms of oxide-based mol % is preferably 10.0% or less, more preferably 8.0% or less, still more preferably 6.0% or less, further still more preferably 5.0% or less, further still more preferably 4.5% or less, further still more preferably 4.0% or less, and further still more preferably 3.0% or less. In the glass 10, the content of Y₂O₃ in terms of oxide-based mol % is preferably 0% or more and 10.0% or less, more preferably 0.5% or more and 8.0% or less, still more preferably 1.0% or more and 6.0% or less, further still more preferably 1.5% or more and 5.0% or less, further still more preferably 2.0% or more and 4.5% or less, further still more preferably 2.5% or more and 4.0% or less, and further still more preferably 2.5% or more and 3.0% or less. When the content of Y₂O₃ falls within this range, a refractive index of the glass and devitrification resistance thereof are improved.

### BaO

The glass 10 may contain BaO or may contain no BaO. In the glass 10, the content of BaO in terms of oxide-based mol % is preferably 0% or more, more preferably 0.5% or more, still more preferably 1.0% or more, further still more preferably 1.5% or more, further still more preferably 2.0% or more, further still more preferably 2.5% or more, and further still more preferably 3.0% or more. In the glass 10, the content of BaO in terms of oxide-based mol % is preferably 10% or less, more preferably 9.0% or less, still more preferably 8.0% or less, further still more preferably 7.0% or less, further still more preferably 6.0% or less, further still more preferably 5.0% or less, and further still more preferably 4.0% or less. In the glass 10, the content of BaO in terms of oxide-based mol % is preferably 0% or more and 10% or less, more preferably 0.5% or more and 9.0% or less, still more preferably 1.0% or more and 8.0% or less, further still more preferably 1.5% or more and 7.0% or less, further still more preferably 2.0% or more and 6.0% or less, further still more preferably 2.5% or more and 5.0% or less, and further still more preferably 3.0% or more and 4.0% or less. When the content of BaO falls within this range, a refractive index of the glass, devitrification resistance thereof, and a transmittance with respect to visible light are improved.

Bi₂O₃

The glass 10 may contain Bi₂O₃ or may contain no Bi₂O₃. In the glass 10, the content of Bi₂O₃ in terms of oxide-based mol % is preferably 0% or more, more preferably 0.5% or more, still more preferably 1.0% or more, further still more preferably 2.0% or more, further still more preferably 4.0% or more, and further still more preferably 6.0% or more. In the glass 10, the content of Bi₂O₃ in terms of oxide-based mol % is preferably 30.0% or less, more preferably 25.0% or less, still more preferably 20.0% or less, further still more preferably 15.0% or less, and further still more preferably 10.0% or less. In the glass 10, the content of Bi₂O₃ in terms of oxide-based mol % is preferably 0% or more and 30.0% or less, more preferably 0.5% or more and 25.0% or less, still more preferably 1.0% or more and 20.0% or less, further still more preferably 2.0% or more and 20.0% or less, further still more preferably 4.0% or more and 15.0% or less, and further still more preferably 6.0% or more and 10.0% or less. When the content of Bi₂O₃ falls within this range, a high refractive index and a high transmittance can be appropriately achieved.

Gd₂O₃

The glass 10 preferably contains Gd₂O₃. In the glass 10, the content of Gd₂O₃ in terms of oxide-based mol % is preferably 0% or more, more preferably 1.0% or more, still more preferably 2.0% or more, further still more preferably 3.0% or more, further still more preferably 4.0% or more, and further still more preferably 4.5% or more. In the glass 10, the content of Gd₂O₃ in terms of oxide-based mol % is preferably 10% or less, more preferably 9.0% or less, still more preferably 8.0% or less, further still more preferably 7.0% or less, further still more preferably 6.0% or less, and further still more preferably 5.0% or less. In the glass 10, the content of Gd₂O₃ in terms of oxide-based mol % is preferably 0% or more and 10% or less, more preferably 1.0% or more and 9.0% or less, still more preferably 2.0% or more and 8.0% or less, further still more preferably 3.0% or more and 7.0% or less, further still more preferably 4.0% or more and 6.0% or less, and further still more preferably 4.5% or more and 5.0% or less. When the content of Gd₂O₃ falls within this range, a refractive index of the glass and devitrification resistance thereof are improved.

Nb₂O₅

The glass 10 preferably contains Nb₂O₅. In the glass 10, the content of Nb₂O₅ in terms of oxide-based mol % is preferably 0% or more, more preferably 1.0% or more, still more preferably 2.0% or more, further still more preferably 3.0% or more, further still more preferably 4.0% or more, and further still more preferably 4.5% or more. In the glass 10, the content of Nb₂O₅ in terms of oxide-based mol % is preferably 10.0% or less, more preferably 9.0% or less, still more preferably 8.0% or less, further still more preferably 7.0% or less, further still more preferably 6.0% or less, and further still more preferably 5.5% or less. In the glass 10, the content of Nb₂O₅ in terms of oxide-based mol % is preferably 0% or more and 10.0% or less, more preferably 1.0% or more and 9.0% or less, still more preferably 2.0% or more and 8.0% or less, further still more preferably 3.0% or more and 7.0% or less, further still more preferably 4.0% or more and 6.0% or less, further still more preferably 5.0% or more and 6.0% or less, and further still more preferably 4.5% or more and 5.5% or less. When the content of Nb₂O₅ falls within this range, a refractive index of the glass and devitrification resistance thereof are improved.

### ZnO

The glass 10 preferably contains ZnO. In the glass 10, the content of ZnO in terms of oxide-based mol % is preferably 0% or more, more preferably 1.0% or more, still more preferably 2.0% or more, and further still more preferably 3.0% or more. In the glass 10, the content of ZnO in terms of oxide-based mol % is preferably 20.0% or less, more preferably 15.0% or less, still more preferably 10.0% or less, and further still more preferably 6.0% or less. In the glass 10, the content of ZnO in terms of oxide-based mol % is preferably 0% or more and 20.0% or less, more preferably 1.0% or more and 15.0% or less, still more preferably 2.0% or more and 10% or less, and further still more preferably 3.0% or more and 6.0% or less. When the content of ZnO falls within this range, a liquid phase temperature of the glass is lowered to suppress defect deposition.

### WO₃

The glass 10 may contain WO₃ or may contain no WO₃. In the glass 10, the content of WO₃ in terms of oxide-based mol % is preferably 0% or more, more preferably 0.1% or more, still more preferably 0.2% or more, further still more preferably 0.3% or more, and further still more preferably 0.5% or more. In the glass 10, the content of WO₃ in terms of oxide-based mol % is preferably 30.0% or less, more preferably 20.0% or less, still more preferably 10.0% or less, further still more preferably 2.00% or less, and further still more preferably 1.0% or less. In the glass 10, the content of WO₃ in terms of oxide-based mol % is preferably 0% or more and 30.0% or less, more preferably 0.1% or more and 20.0% or less, still more preferably 0.2% or more and 10.0% or less, further still more preferably 0.3% or more and 2.0% or less, and further still more preferably 0.5% or more and 1.0% or less. When the content of WO₃ falls within this range, a decrease in liquid phase temperature of the glass and a high refractive index can be appropriately achieved.

Ta₂O₅

The glass 10 may contain Ta₂O₅ or may contain no Ta₂O₅. In the glass 10, the content of Ta₂O₅ in terms of oxide-based mol % is preferably 0% or more, more preferably 0.1% or more, still more preferably 0.2% or more, and further still more preferably 0.3% or more. In the glass 10, the content of Ta₂O₅ in terms of oxide-based mol % is preferably 10.0% or less, more preferably 5.0% or less, still more preferably 1.0% or less, and further still more preferably 0.5% or less. In the glass 10, the content of Ta₂O₅ in terms of oxide-based mol % is preferably 0% or more and 10.0% or less, more preferably 0.1% or more and 5.0% or less, still more preferably 0.2% or more and 1.0% or less, and further still more preferably 0.3% or more and 0.5% or less. When the content of Ta₂O₅ falls within this range, a high refractive index and a reduction in glass manufacturing cost can be appropriately achieved.

P₂O₅

The glass 10 may contain P₂O₅ or may contain no P₂O₅. In the glass 10, the content of P₂O₅ in terms of oxide-based mol % is preferably 0% or more, more preferably 0.5% or more, still more preferably 1.0% or more, further still more preferably 1.5% or more, further still more preferably 2.0% or more, and further still more preferably 2.5% or more. In the glass 10, the content of P₂O₅ in terms of oxide-based mol % is preferably 30.0% or less, more preferably 25.0% or less, still more preferably 20.0% or less, further still more preferably 15.0% or less, further still more preferably 10.0% or less, and further still more preferably 5.0% or less. In the glass 10, the content of P₂O₅ in terms of oxide-based mol % is preferably 0% or more and 30.0% or less, more preferably 0.5% or more and 25.0% or less, still more preferably 1.0% or more and 20.0% or less, further still more preferably 1.5% or more and 15.0% or less, further still more preferably 2.0% or more and 10.0% or less, and further still more preferably 2.5% or more and 5.0% or less. When the content of P₂O₅ falls within this range, coloring of the glass is reduced to increase a transmittance with respect to short-wavelength visible light, and stable glass formation is promoted to improve devitrification resistance of the glass.

### ZrO₂

The glass 10 preferably contains ZrO₂. In the glass 10, the content of ZrO₂ in terms of oxide-based mol % is preferably 0% or more, more preferably 1.0% or more, still more preferably 2.0% or more, further still more preferably 3.0% or more, further still more preferably 4.0% or more, further still more preferably 5.0% or more, further still more preferably 6.0% or more, and further still more preferably 7.0% or more. In the glass 10, the content of ZrO₂ in terms of oxide-based mol % is preferably 15.0% or less, more preferably 14.0% or less, still more preferably 13.0% or less, further still more preferably 12.0% or less, further still more preferably 11.0% or less, further still more preferably 10.0% or less, further still more preferably 9.0% or less, and further still more preferably 8.0% or less. In the glass 10, the content of ZrO₂ in terms of oxide-based mol % is preferably 0% or more and 15.0% or less, more preferably 1.0% or more and 14.0% or less, still more preferably 2.0% or more and 13.0% or less, further still more preferably 3.0% or more and 12.0% or less, further still more preferably 4.0% or more and 11.0% or less, further still more preferably 5.0% or more and 10.0% or less, further still more preferably 6.0% or more and 9.0% or less, and further still more preferably 7.0% or more and 8.0% or less. When the content of ZrO₂ falls within this range, coloring of the glass is reduced to increase a transmittance with respect to short-wavelength visible light, and stable glass formation is promoted to improve devitrification resistance of the glass.

### TiO₂

The glass 10 preferably contains TiO₂. In the glass 10, the content of TiO₂ in terms of oxide-based mol % is preferably 0% or more, more preferably 5.0% or more, still more preferably 10.0% or more, further still more preferably 15.0% or more, further still more preferably 20.0% or more, further still more preferably 25.0% or more, further still more preferably 28.0% or more, further still more preferably 29.0% or more, further still more preferably 30.0% or more, and further still more preferably 31.0% or more. In the glass 10, the content of TiO₂ in terms of oxide-based mol % is preferably 40.0% or less, more preferably 35.0% or less, still more preferably 34.0% or less, further still more preferably 33.0% or less, further still more preferably 32.0% or less, further still more preferably 31.5% or less, and further still more preferably 31.0% or less. In the glass 10, the content of TiO₂ in terms of oxide-based mol % is preferably 0% or more and 40% or less, more preferably 5.0% or more and 35% or less, still more preferably 10% or more and 34.0% or less, further still more preferably 15.0% or more and 33.0% or less, further still more preferably 20.0% or more and 32.0% or less, further still more preferably 25.0% or more and 32.0% or less, further still more preferably 28.0% or more and 32.0% or less, further still more preferably 29.0% or more and 32.0% or less, further still more preferably 30.0% or more and 32.0% or less, further still more preferably 31.0% or more and 31.5% or less, and further still more preferably 31.0%. When the content of TiO₂ falls within this range, a refractive index and chemical durability of the glass are improved.

La₂O₃

The glass 10 preferably contains La₂O₃. In the glass 10, the content of La₂O₃ in terms of oxide-based mol % is preferably 0% or more, more preferably 5.0% or more, still more preferably 10.0% or more, further still more preferably 15.0% or more, further still more preferably 16.0% or more, further still more preferably 17.0% or more, further still more preferably 18.0% or more, further still more preferably 19.0% or more, and further still more preferably 20.0% or more. In the glass 10, the content of La₂O₃ in terms of oxide-based mol % is preferably 40.0% or less, more preferably 35.0% or less, still more preferably 30.0% or less, further still more preferably 28.0% or less, further still more preferably 27.0% or less, further still more preferably 26.0% or less, further still more preferably 25.0% or less, further still more preferably 24.0% or less, and further still more preferably 22.0% or less. In the glass 10, the content of La₂O₃ in terms of oxide-based mol % is preferably 0% or more and 40.0% or less, more preferably 5.0% or more and 35.0% or less, still more preferably 10.0% or more and 35.0% or less, further still more preferably 15.0% or more and 30.0% or less, further still more preferably 16.0% or more and 28.0% or less, further still more preferably 17.0% or more and 27.0% or less, further still more preferably 18.0% or more and 26.0% or less, further still more preferably 19.0% or more and 25.0% or less, further still more preferably 20.0% or more and 24.0% or less, and further still more preferably 20.0% or more and 22.0% or less. When the content of La₂O₃ falls within this range, improvement in high refractive index and chemical durability can be appropriately achieved.

### Ti³⁺/Ti

In the above description, when Ti is contained in the glass 10, the content thereof is defined by converting the contained Ti into TiO₂ (that is, assuming that all atoms of Ti are in a tetravalent Ti (Ti⁴⁺) state). However, it is not limited to the situation in which all atoms of Ti are in a tetravalent Ti (Ti⁴⁺) state, and at least some atoms of Ti may be contained in a trivalent Ti (Ti³⁺) state, for example.

In this case, a ratio (Ti³⁺/Ti) of the content of trivalent Ti (Ti³⁺) to the total content (Ti) of Ti contained in the glass 10 in terms of a mass ratio is preferably less than 0.100, more preferably 0.0800 or less, still more preferably 0.0600 or less, further still more preferably 0.0500 or less, further still more preferably 0.0400 or less, further still more preferably 0.0300 or less, further still more preferably 0.0200 or less, and further still more preferably 0.0100 or less. The ratio (Ti³⁺/Ti) in terms of a mass ratio is more preferably 0 or more, still more preferably 0.0005 or more, further still more preferably 0.0010 or more, further still more preferably 0.0020 or more, further still more preferably 0.0040 or more, further still more preferably 0.0060 or more, and further still more preferably 0.0080 or more. The ratio (Ti³⁺/Ti) in terms of a mass ratio is preferably less than 0.100, more preferably 0 or more and 0.0800 or less, still more preferably 0.0005 or more and 0.0600 or less, further still more preferably 0.0010 or more and 0.0500 or less, further still more preferably 0.0020 or more and 0.0400 or less, further still more preferably 0.0040 or more and 0.0300 or less, further still more preferably 0.0060 or more and 0.0200 or less, and further still more preferably 0.0080 or more and 0.0100 or less. When the content of trivalent Ti falls within this range, a high refractive index and a high transmittance can be appropriately achieved. Note that the total content of Ti refers to the total content of Ti of all valences such as divalent, trivalent, and tetravalent.

The content of Ti can be measured by ICP mass spectrometry. As a measuring instrument, for example, Agilent 8800 manufactured by Agilent Technologies can be used. The content of Ti³⁺ can be measured by an electron spin resonance apparatus (ESR). As a measuring instrument, for example, EMXnano manufactured by Bruker can be used. Hereinafter, measurement conditions of the ESR used in the above-described experiment will be described.

The content of Ti³⁺ was determined by integrating a peak of g=1.93±0.01 twice to determine an intensity, and comparing the intensity with an intensity similarly determined for a standard sample having a known concentration. g represents a value calculated by the following formula. An integration range is set such that only peaks are integrated.

g=hν/βH (in which h is Planck's constant, ν is a microwave frequency, β is the Bohr magneton of an electron, and H is an absorption magnet.)
Sample amount: 0.5 g
Microwave frequency: 9.57 to 9.60 GHz (adjusted for each measurement)
Output: 1 to 10 mW (adjusted for each measurement)
Sweep range: 1000 to 4000 gauss
Modulation frequency: 100 kHz
Modulation magnetic field: 5 gauss
Magnetic field sweep time: 30 to 60 sec (adjusted for each measurement)
Time constant: 1.28 msec
Measurement temperature: room temperature

In addition, a ratio (Ti⁴⁺/Ti) of the content of tetravalent Ti (Ti⁴⁺) to the total content (Ti) of Ti contained in the glass 10 in terms of a mass ratio is preferably 0.9000 or more, more preferably 0.9200 or more, still more preferably 0.9400 or more, and further still more preferably 0.9600 or more. The ratio (Ti⁴⁺/Ti) in terms of a mass ratio is preferably 1.0000 or less, more preferably 0.9950 or less, still more preferably 0.9900 or less, and further still more preferably 0.9850 or less. The ratio (Ti⁴⁺/Ti) in terms of a mass ratio is preferably 0.9000 or more and 1.0000 or less, more preferably 0.9200 or more and 0.9950 or less, still more preferably 0.9400 or more and 0.9900 or less, and further still more preferably 0.9600 or more and 0.9850 or less. When the content of tetravalent Ti falls within this range, a high refractive index and a high transmittance can be appropriately achieved.

### Sb

The glass 10 preferably contains no Sb. By containing no Sb, the glass 10 can appropriately reduce a load on the environment. Note that the phrase “containing no Sb” means that it is allowed to contain Sb as an inevitable impurity.

Sb here does not refer to only an elemental metal of Sb contained in the glass 10, and may include an elemental metal and a compound of Sb.

Whether or not the glass 10 contains Sb can be measured by ICP mass spectrometry. As a measuring instrument, for example, Agilent 8800 manufactured by Agilent Technologies can be used.

### Characteristics of Glass

Characteristics of the glass 10 other than those described above will be described below.

### Transmittance τ₄₄₀

The transmittance τ₄₄₀ of the glass 10 is preferably 0.800 or more, more preferably 0.820 or more, still more preferably 0.840 or more, further still more preferably 0.860 or more, further still more preferably 0.870 or more, further still more preferably 0.880 or more, further still more preferably 0.890 or more, and further still more preferably 0.900 or more. The transmittance τ₄₄₀ of the glass 10 is preferably 1.000 or less, more preferably 0.990 or less, still more preferably 0.980 or less, further still more preferably 0.970 or less, further still more preferably 0.965 or less, further still more preferably 0.960 or less, and further still more preferably 0.955 or less. The transmittance τ₄₄₀ of the glass 10 is preferably 0.820 or more and 1.000 or less, more preferably 0.840 or more and 0.990 or less, still more preferably 0.860 or more and 0.980 or less, further still more preferably 0.870 or more and 0.970 or less, further still more preferably 0.880 or more and 0.965 or less, further still more preferably 0.890 or more and 0.960 or less, and further still more preferably 0.900 or more and 0.955 or less. When the transmittance τ₄₄₀ falls within this range, the glass 10 can appropriately transmit visible light. Note that, as described above, the transmittance τ₄₄₀ is an internal transmittance with respect to light having a wavelength of 440 nm when the thickness is converted to 10 mm.

### Transmittance τ₄₆₀

The transmittance τ₄₆₀ of the glass 10 is preferably 0.850 or more, more preferably 0.870 or more, still more preferably 0.890 or more, further still more preferably 0.900 or more, further still more preferably 0.910 or more, further still more preferably 0.920 or more, and further still more preferably 0.930 or more. The transmittance τ₄₆₀ of the glass 10 is preferably 1.000 or less, more preferably 0.990 or less, still more preferably 0.980 or less, further still more preferably 0.975 or less, further still more preferably 0.970 or less, and further still more preferably 0.965 or less. The transmittance τ₄₆₀ of the glass 10 is preferably 0.870 or more and 1.000 or less, more preferably 0.890 or more and 0.990 or less, still more preferably 0.900 or more and 0.980 or less, further still more preferably 0.910 or more and 0.975 or less, further still more preferably 0.920 or more and 0.970 or less, and further still more preferably 0.930 or more and 0.965 or less. When the transmittance τ₄₆₀ falls within this range, the glass 10 can appropriately transmit visible light. Note that, as described above, the transmittance τ₄₆₀ is an internal transmittance with respect to light having a wavelength of 460 nm when the thickness is converted to 10 mm.

### Wavelength λ₅

The wavelength λ₅ of the glass 10 is preferably 430 nm or less, more preferably 425 nm or less, still more preferably 420 nm or less, further still more preferably 415 nm or less, further still more preferably 410 nm or less, and further still more preferably 405 nm or less. The wavelength λ₅ of the glass 10 is more preferably 350 nm or more, still more preferably 355 nm or more, further still more preferably 360 nm or more, further still more preferably 365 nm or more, and further still more preferably 370 nm or more. The wavelength λ₅ of the glass 10 is preferably 430 nm or less, more preferably 350 nm or more and 425 nm or less, still more preferably 355 nm or more and 420 nm or less, further still more preferably 360 nm or more and 415 nm or less, further still more preferably 365 nm or more and 410 nm or less, and further still more preferably 370 nm or more and 405 nm or less. When the wavelength λ₅ falls within this range, the glass 10 can appropriately transmit visible light. Note that the wavelength λ₅ refers to a wavelength indicating an internal transmittance of 5% at a plate thickness (thickness) of 10 mm.

### Abbe Number v_{d}

The Abbe number v_{d} of the glass 10 is preferably 17.00 or more, more preferably 19.00 or more, still more preferably 23.00 or more, further still more preferably 25.00 or more, further still more preferably 26.00 or more, and further still more preferably 27.00 or more. The Abbe number v_{d} of the glass 10 is preferably 35.00 or less, more preferably 33.00 or less, still more preferably 32.00 or less, further still more preferably 31.00 or less, further still more preferably 30.00 or less, and further still more preferably 29.00 or less. The Abbe number v_{d} of the glass 10 is preferably 17.00 or more and 35.00 or less, more preferably 19.00 or more and 33.00 or less, still more preferably 23.00 or more and 32.00 or less, further still more preferably 25.00 or more and 31.00 or less, further still more preferably 26.00 or more and 30.00 or less, and further still more preferably 27.00 or more and 29.00 or less. Note that the Abbe number v_{d} is a value indicating a property related to dispersion. The Abbe number v_{d} can be measured by a V block method.

### Devitrification Temperature

The devitrification temperature of the glass 10 is preferably 1250° C. or lower, more preferably 1240° C. or lower, still more preferably 1230° C. or lower, further still more preferably 1220° C. or lower, further still more preferably 1210° C. or lower, further still more preferably 1200° C. or lower, further still more preferably 1190° C. or lower, further still more preferably 1180° C. or lower, further still more preferably 1170° C. or lower, further still more preferably 1160° C. or lower, further still more preferably 1150° C. or lower, further still more preferably 1140° C. or lower, further still more preferably 1130° C. or lower, and further still more preferably 1120° C. or lower. When the devitrification temperature falls within this range, a temperature at which a raw material is dissolved at the time of manufacturing the glass 10 can be made relatively low, Pt and Fe contained in the raw material or facility can be suppressed from being dissolved and mixed into the glass, and the contents of Pt and Fe can be reduced.

The devitrification temperature can be measured by the following method. A sample glass was pulverized, and glass grains that passed through a 4 mm sieve and remained on a 2 mm sieve were obtained. The glass grains were immersed in ethanol, ultrasonically washed, and then dried in a dryer. About 5 g of the dried glass grains were placed on a platinum dish and held at 1000° C. to 1400° C. in 10° C. increments for one hour, and cooled by natural cooling. Thereafter, presence or absence of crystal deposition was observed with a microscope, and a minimum temperature at which crystals of 1 μm or more in long side or long diameter were not observed was defined as the devitrification temperature.

### Young's Modulus E

The Young's modulus E of the glass 10 is preferably 90 GPa or more, more preferably 95 GPa or more, still more preferably 100 GPa or more, further still more preferably 105 GPa or more, further still more preferably 110 GPa or more, further still more preferably 117 GPa or more, further still more preferably 120 GPa or more, further still more preferably 122 GPa or more, further still more preferably 124 GPa or more, and further still more preferably 126 GPa or more. The Young's modulus E of the glass 10 is preferably 155 GPa or less, more preferably 150 GPa or less, still more preferably 148 GPa or less, further still more preferably 145 GPa or less, further still more preferably 143 GPa or less, further still more preferably 141 GPa or less, further still more preferably 139 GPa or less, further still more preferably 137 GPa or less, and further still more preferably 135 GPa or less. The Young's modulus E of the glass 10 is preferably 95 GPa or more and 155 GPa or less, more preferably 100 GPa or more and 150 GPa or less, still more preferably 105 GPa or more and 148 GPa or less, further still more preferably 110 GPa or more and 145 GPa or less, further still more preferably 117 GPa or more and 143 GPa or less, further still more preferably 120 GPa or more and 141 GPa or less, further still more preferably 122 GPa or more and 139 GPa or less, further still more preferably 124 GPa or more and 137 GPa or less, and further still more preferably 126 GPa or more and 135 GPa or less. By having such a high Young's modulus, the glass 10 can appropriately suppress breakage thereof. Note that the Young's modulus can be measured on the basis of propagation of an ultrasonic wave using 38DL PLUS manufactured by OLYMPUS Corporation.

### Specific Gravity d

The specific gravity d of the glass 10 is preferably 6.20 g/cm³ or less, more preferably 6.17 g/cm³ or less, still more preferably 5.70 g/cm³ or less, further still more preferably 5.50 g/cm³ or less, further still more preferably 5.40 g/cm³ or less, further still more preferably 5.30 g/cm³ or less, further still more preferably 5.20 g/cm³ or less, further still more preferably 5.00 g/cm³ or less, and further still more preferably 4.50 or less. The specific gravity d of the glass 10 is preferably 3.40 g/cm³ or more, more preferably 3.50 g/cm³ or more, still more preferably 3.60 g/cm³ or more, further still more preferably 3.70 g/cm³ or more, further still more preferably 3.80 g/cm³ or more, and further still more preferably 3.90 g/cm³ or more. The specific gravity d of the glass 10 is preferably 3.40 g/cm³ or more and 6.17 g/cm³ or less, more preferably 3.50 g/cm³ or more and 5.70 g/cm³ or less, still more preferably 3.60 g/cm³ or more and 5.50 g/cm³ or less, further still more preferably 3.70 g/cm³ or more and 5.40 g/cm³ or less, further still more preferably 3.80 g/cm³ or more and 5.30 g/cm³ or less, further still more preferably 3.90 g/cm³ or more and 5.20 g/cm³ or less, and further still more preferably 4.00 g/cm³ or more and 5.00 g/cm³ or less. By having such a low specific gravity, the glass 10 is easily handled. Note that the specific gravity d can be measured by an Archimedes method.

### Form of Glass

The glass 10 according to the present embodiment is preferably an optical glass, and is preferably a glass plate having a thickness of 0.01 mm or more and 2.0 mm or less. When the thickness is 0.01 mm or more, breakage of the glass 10 during handling or processing can be suppressed. In addition, deflection of the glass 10 due to its own weight can be suppressed. This thickness is more preferably 0.1 mm or more, still more preferably 0.2 mm or more, and further still more preferably 0.3 mm or more. On the other hand, when the thickness is 2.0 mm or less, an optical element using the glass 10 can be made lightweight. This thickness is more preferably 1.5 mm or less, still more preferably 1.0 mm or less, and further still more preferably 0.8 mm or less.

When the glass 10 according to the present embodiment is a glass plate, the area of a main surface is preferably 8 cm² or more. When this area is 8 cm² or more, a large number of optical elements can be arranged, and productivity is improved. This area is more preferably 30 cm² or more, still more preferably 170 cm² or more, further still more preferably 300 cm² or more, and particularly preferably 1000 cm² or more. On the other hand, when the area is 6500 cm² or less, handling of the glass plate is easy, and breakage of the glass plate during handling or processing can be suppressed. This area is more preferably 4500 cm² or less, still more preferably 4000 cm² or less, further still more preferably 3000 cm² or less, and particularly preferably 2000 cm² or less.

When the glass 10 according to the present embodiment is a glass plate, local thickness variation (LTV) at 25 cm² of a main surface is preferably 2 μm or less. By having a flatness in this range, a nanostructure having a desired shape can be formed on the main surface using an imprinting technique or the like, and desired light guiding characteristics can be obtained. In particular, in a light guide body, a ghost phenomenon and distortion due to a difference in optical path length can be prevented. This LTV is more preferably 1.5 μm or less, still more preferably 1.0 μm or less, and particularly preferably 0.5 μm or less.

When the glass 10 according to the present embodiment is a circular glass plate having a diameter of 8 to 12 inches, the glass 10 preferably has a warpage of 50 μm or less. When the warpage of the glass 10 is 50 μm or less, a nanostructure having a desired shape can be formed on the main surface using an imprinting technique or the like, and desired light guiding characteristics can be obtained. When a plurality of light guide bodies are to be obtained, light guide bodies having stable quality can be obtained. The warpage of the glass 10 is more preferably 40 μm or less, still more preferably 30 μm or less, and particularly preferably 20 μm or less.

When the glass 10 according to the present embodiment is a circular glass plate having a diameter of 6 inches, the glass 10 preferably has a warpage of 30 μm or less. When the warpage of the glass 10 is 30 μm or less, a nanostructure having a desired shape can be formed on the main surface using an imprinting technique or the like, and desired light guiding characteristics can be obtained. When a plurality of light guide bodies are to be obtained, light guide bodies having stable quality can be obtained. The warpage of the glass 10 is more preferably 20 μm or less, still more preferably 15 μm or less, and particularly preferably 10 μm or less.

When the glass 10 according to the present embodiment is a square glass plate having each side of 6 inches, the glass 10 preferably has a warpage of 100 μm or less. When the warpage of the glass 10 is 100 μm or less, a nanostructure having a desired shape can be formed on the main surface using an imprinting technique or the like, and desired light guiding characteristics can be obtained. When a plurality of light guide bodies are to be obtained, light guide bodies having stable quality can be obtained. The warpage of the glass 10 is more preferably 70 μm or less, still more preferably 50 μm or less, further still more preferably 35 μm or less, and particularly preferably 20 μm or less.

FIG. 2 is a cross-sectional view when the glass according to the present embodiment is a glass plate. The “warpage” is a difference C between a maximum value B and a minimum value A of a distance in a vertical direction between a reference line G1D of a glass plate G1 and a center line G1C of the glass plate G1 in any cross section passing through a center of a main surface G1F of the glass plate G1 and orthogonal to the main surface G1F of the glass plate G1, in which the glass plate G1 is the glass 10 according to the present embodiment.

An intersection line between the any orthogonal cross section and the main surface G1F of the glass plate G1 is defined as a bottom line G1A. An intersection line between the any orthogonal cross section and the other main surface G1G of the glass plate G1 is defined as an upper line G1B. Here, the center line G1C is a line connecting centers of the glass plate G1 in a plate thickness direction. The center line G1C is calculated by obtaining a midpoint between the bottom line G1A and the upper line G1B in a laser irradiation direction described later.

The reference line G1D is obtained as follows. First, the bottom line G1A is calculated under a measurement method for canceling an influence of the own weight of the glass plate G1. A straight line is obtained from the bottom line G1A by a least square method. The obtained straight line is the reference line G1D. As a measurement method for canceling an influence of the own weight of the glass plate G1, a known method is used.

For example, the main surface G1F of the glass plate G1 is supported at three points, the glass plate G1 is irradiated with a laser by a laser displacement meter, and the heights of the main surface G1F and the other main surface G1G of the glass plate G1 from any reference surface are measured.

Next, the glass plate G1 is inverted, three points of the other main surface G1G opposite to the three points supporting the one main surface G1F are supported, and the heights of the main surface G1F and the other main surface G1G of the glass plate G1 from any reference surface are measured.

An influence of the own weight of the glass plate G1 is canceled by obtaining an average of the heights of the measurement points before and after the inversion. For example, before the inversion, as described above, the height of the main surface G1F is measured. After the inversion of the glass plate G1, the height of the other main surface G1G is measured at a position corresponding to the measurement point of the main surface G1F. Similarly, before the inversion, the height of the other main surface G1G is measured. After the inversion of the glass plate G1, the height of the main surface G1F is measured at a position corresponding to the measurement point of the other main surface G1G.

The warpage is measured by, for example, a laser displacement meter.

In the glass 10 according to the present embodiment, a surface roughness Ra of the main surface is preferably 2 nm or less. By having Ra in this range, a nanostructure having a desired shape can be formed on the main surface using an imprinting technique or the like, and desired light guiding characteristics can be obtained. In particular, in a light guide body, irregular reflection at an interface is suppressed, and a ghost phenomenon and distortion can be prevented. Ra is more preferably 1.7 nm or less, still more preferably 1.4 nm or less, still more preferably 1.2 nm or less, and particularly preferably 1 nm or less. Here, the surface roughness Ra is an arithmetic average roughness defined in JIS B0601 (2001). In the present specification, the surface roughness Ra is a value obtained by measuring an area of 10 μm×10 μm using an atomic force microscope (AFM).

### Method for Manufacturing Glass

A method for manufacturing the glass 10 according to the present embodiment is not particularly limited, but a preferred method for manufacturing the glass 10 will be described below.

In the present embodiment, a step of preparing raw materials of the glass 10, a step of dissolving the raw materials, and a step of cooling the dissolved raw materials to obtain the glass 10 are included. In the present manufacturing method, an existing plate glass manufacturing method can be used. For example, known methods such as a float method, a fusion method, and a roll-out method can be used.

As the raw materials of the glass 10, types are selected according to the composition of the glass 10 to be obtained, and the raw materials are mixed at a blending ratio according to the composition of the glass 10 to be obtained. In the present embodiment, a ratio of Fe contained in the raw materials to the total amount of the raw materials (Fe/total of raw materials) in terms of a mass ratio is preferably 0 ppm or more, more preferably 0.2 ppm or more, still more preferably 0.5 ppm or more, further still more preferably 0.8 ppm or more, further still more preferably 1.0 ppm or more, and further still more preferably 1.5 ppm or more. The ratio of Fe contained in the raw materials to the total amount of the raw materials (Fe/total of raw materials) in terms of a mass ratio is preferably 15.0 ppm or less, more preferably 10.0 ppm or less, still more preferably 7.0 ppm or less, further still more preferably 5.0 ppm or less, further still more preferably 4.0 ppm or less, and further still more preferably 3.0 ppm or less. The ratio of Fe contained in the raw materials to the total amount of the raw materials (Fe/total of raw materials) in terms of a mass ratio is preferably 0 ppm or more and 15.0 ppm or less, more preferably 0.2 ppm or more and 10.0 ppm or less, still more preferably 0.5 ppm or more and 7.0 ppm or less, further still more preferably 0.8 ppm or more and 5.0 ppm or less, further still more preferably 1.0 ppm or more and 4.0 ppm or less, and further still more preferably 1.5 ppm or more and 3.0 ppm or less. As a result, the content of Fe in the glass 10 can be reduced.

Fe here does not refer to only an elemental metal of Fe contained in the raw materials, and may include an elemental metal of Fe and a compound thereof.

The content of Fe can be measured by ICP mass spectrometry. As a measuring instrument, for example, Agilent 8800 manufactured by Agilent Technologies can be used.

In the step of dissolving raw materials, the raw materials are put into a container such as a crucible, and the raw materials put into the container are heated to dissolve the raw materials. As the container, any material may be used, but in the present embodiment, a container containing Pt is used.

A heating temperature at the time of dissolving the raw materials is preferably 950° C. or higher, more preferably 1000° C. or higher, still more preferably 1050° C. or higher, further still more preferably 1100° C. or higher, and further still more preferably 1120° C. or higher. The heating temperature at the time of dissolving the raw materials is preferably 1600° C. or lower, more preferably 1500° C. or lower, still more preferably 1400° C. or lower, further still more preferably 1350° C. or lower, and further still more preferably 1300° C. or lower. The heating temperature at the time of dissolving the raw materials is preferably 950° C. or higher and 1600° C. or lower, more preferably 1000° C. or higher and 1500° C. or lower, still more preferably 1050° C. or higher and 1400° C. or lower, further still more preferably 1100° C. or higher and 1350° C. or lower, and further still more preferably 1120° C. or higher and 1300° C. or lower. By setting the heating temperature within this range, dissolution of Pt contained in the container or Fe contained in the raw materials and the like is suppressed, and the contents of Pt and Fe in the glass 10 can be reduced.

### Effect

As described above, the glass 10 according to a first aspect of the present disclosure contains La₂O₃ and B₂O₃, has a refractive index n_{d} of 2.0100 or more, has a total content of Bi₂O₃ and B₂O₃ of less than 80% in terms of oxide-based mol %, has a total content of Pt and Fe of 0.5 ppm or more and 15.0 ppm or less in terms of a mass ratio, and has a parameter A defined by the formula (1) of 0.870 or more.

The present inventor has found that a high-refractive index glass containing La₂O₃ and B₂O₃ and having a total content of Bi₂O₃ and B₂O₃ of less than 80% tends to have a low transmittance. In addition, the present inventor has found that since the high-refractive index glass tends to have a high dissolution temperature, the elution amounts of Pt and Fe increase in a manufacturing process, and the contents of Pt and Fe in the manufactured glass increase. When the contents of Pt and Fe increase, Pt and Fe tend to be deposited as defects.

On the other hand, as a result of intensive studies, the present inventor has found that when the total content of Pt and Fe is 0.5 ppm or more and 15 ppm or less and the parameter A is 0.880 or more, a decrease in transmittance can be suppressed while deposition of Pt and Fe as defects is suppressed. That is, by satisfying the above conditions, the glass of the present disclosure can appropriately maintain a balance among the amounts of Pt and Fe, the transmittance, and the manufacturing conditions, and can suppress deposition of defects while achieving a high refractive index and a high transmittance.

A glass 10 according to a second aspect of the present disclosure is the glass 10 according to the first aspect, which preferably has a parameter B defined by the formula (2) of 2.075 or more. The glass 10 of the present disclosure can maintain a high transmittance with respect to visible light even having a high refractive index.

A glass 10 according to a third aspect of the present disclosure is the glass 10 according to the first aspect or the second aspect, which preferably has a devitrification temperature of 1250° C. or lower. Since the glass 10 of the present disclosure has a devitrification temperature of 1250° C. or lower, a temperature at which the raw materials are dissolved at the time of manufacturing the glass 10 can be made relatively low, and the contents of Pt and Fe can be reduced.

A glass 10 according to a fourth aspect of the present disclosure is the glass 10 according to any one of the first to third aspects, which preferably has a Young's modulus of 90 GPa or more. The glass 10 of the present disclosure has a Young's modulus of 90 GPa or more, and therefore can appropriately suppress breakage thereof.

A glass 10 according to a fifth aspect of the present disclosure is the glass 10 according to any one of the first to fourth aspects, in which a ratio of the content of trivalent Ti to the total content of Ti in terms of a mass ratio is preferably less than 0.1000. This makes it possible to appropriately achieve a high refractive index and a high transmittance.

A glass 10 according to a sixth aspect of the present disclosure is the glass 10 according to any one of the first to fifth aspects, which preferably contains no Sb. This makes it possible to appropriately achieve a high refractive index and a high transmittance.

A glass 10 according to a seventh aspect of the present disclosure is the glass 10 according to any one of the first to sixth aspects, which preferably contains, in terms of oxide-based mol %,
SiO₂: 0% or more and 20.0% or less,
B₂O₃: 0% or more and 30.0% or less,
Y₂O₃: 0% or more and 10.0% or less,
BaO: 0% or more and 10.0% or less,
Bi₂O₃: 0% or more and 30.0% or less,
Gd₂O₃: 0% or more and 10.0% or less,
Nb₂O₅: 0% or more and 10.0% or less,
ZnO: 0% or more and 20.0% or less,
WO₃: 0% or more and less than 30.0%,
Ta₂O₅: 0% or more and 10.0% or less,
P₂O₅: 0% or more and 30.0% or less,
ZrO₂: 0% or more and 15.0% or less,
TiO₂: 0% or more and 40.0% or less, and
La₂O₃: 0% or more and 40.0% or less. This makes it possible to appropriately achieve a high refractive index and a high transmittance.

A glass 10 according to an eighth aspect of the present disclosure is the glass 10 according to any one of the first to seventh aspects, which preferably has a specific gravity of 6.20 g/cm³ or less. By having such a low specific gravity, the glass 10 is easily handled.

A glass 10 according to a ninth aspect of the present disclosure is the glass 10 according to any one of the first to eighth aspects, which is preferably used as a light guide plate. The glass 10 of the present disclosure can be appropriately used for a light guide plate.

A method for manufacturing a glass according to a tenth aspect of the present disclosure includes: heating raw materials at 950° C. or higher and 1600° C. or lower to dissolve the raw materials; and cooling the dissolved raw materials to obtain the glass 10 according to any one of the first aspect to the ninth aspect. According to the present disclosure, by setting the heating temperature of the raw materials within the above range, it is possible to manufacture a glass capable of suppressing deposition of defects while reducing the contents of Pt and Fe to achieve a high refractive index and a high transmittance.

### WORKING EXAMPLES

Next, Working Examples will be described. Tables 1 and 2 are Tables presenting glasses of Examples. Note that the embodiment may be changed as long as the effect of the invention is exhibited.

TABLE 1

| | |
|---|---|
| Composition (mol %) | Pt + Fe |

| | SiO₂ | B₂O₃ | Y₂O₃ | BaO | Bi₂O₃ | Gd₂O₃ | Nb₂O₅ | ZnO | WO₃ | Ta₂O₅ | P₂O₅ | ZrO₂ | TiO₂ | La₂O₃ | Total | (ppm) | Ti³⁺/Ti |
|---|---|---|---|---|---|---|---|---|---|---|---|---|---|---|---|---|---|
| Example 72 | 8.3 | 11.3 | 1.6 | 0.2 | 0.0 | 4.1 | 4.2 | 0.1 | 1.0 | 0.1 | 1.0 | 8.0 | 38.0 | 22.1 | 100.0 | 8.5 | 0.023 |
| Example 73 | 13.8 | 13.0 | 1.5 | 0.1 | 0.0 | 4.1 | 4.9 | 0.0 | 0.3 | 0.0 | 0.3 | 7.9 | 39.0 | 15.0 | 100.0 | 18.0 | 0.014 |
| Example 1 | 10.9 | 15.9 | 0.4 | 0.0 | 0.0 | 4.9 | 5.6 | 1.5 | 0.0 | 0.0 | 0.0 | 8.8 | 28.4 | 23.6 | 100.0 | 5.8 | 0.001 |
| Example 2 | 10.9 | 16.9 | 0.4 | 0.0 | 0.0 | 4.5 | 5.6 | 1.5 | 0.0 | 0.0 | 0.0 | 8.8 | 28.4 | 22.6 | 100.0 | 10.5 | 0.002 |
| Example 3 | 10.9 | 15.9 | 0.4 | 0.0 | 0.0 | 4.9 | 6.6 | 1.5 | 0.0 | 0.0 | 0.0 | 8.8 | 28.4 | 22.6 | 100.0 | 8.1 | 0.002 |
| Example 4 | 10.9 | 15.9 | 0.4 | 0.0 | 0.0 | 6.0 | 5.6 | 1.5 | 0.0 | 0.0 | 0.0 | 8.8 | 28.4 | 22.6 | 100.0 | 10.3 | 0.002 |
| Example 5 | 10.8 | 15.7 | 0.4 | 0.0 | 0.0 | 4.9 | 5.5 | 3.5 | 0.0 | 0.0 | 0.0 | 8.7 | 28.1 | 22.4 | 100.0 | 4.2 | 0.002 |
| Example 6 | 10.8 | 15.7 | 0.4 | 0.0 | 0.0 | 4.9 | 5.5 | 1.5 | 0.0 | 0.0 | 0.0 | 10.7 | 28.1 | 22.4 | 100.0 | 5.5 | 0.002 |
| Example 7 | 12.8 | 15.7 | 0.4 | 0.0 | 0.0 | 4.9 | 5.5 | 1.5 | 0.0 | 0.0 | 0.0 | 8.7 | 28.1 | 22.4 | 100.0 | 5.0 | 0.002 |
| Example 8 | 10.9 | 15.9 | 1.4 | 0.0 | 0.0 | 4.9 | 5.6 | 1.5 | 0.0 | 0.0 | 0.0 | 8.8 | 28.4 | 22.6 | 100.0 | 8.7 | <0.001 |
| Example 9 | 10.9 | 15.9 | 0.4 | 0.0 | 0.0 | 4.9 | 5.6 | 1.5 | 0.0 | 0.0 | 0.0 | 10.8 | 26.4 | 22.6 | 100.0 | 4.8 | <0.001 |
| Example 10 | 10.9 | 15.9 | 0.4 | 0.0 | 0.0 | 4.9 | 5.6 | 1.5 | 0.0 | 0.0 | 0.0 | 10.8 | 26.4 | 23.6 | 100.0 | 5.8 | <0.001 |
| Example 11 | 10.9 | 15.9 | 0.4 | 0.0 | 0.0 | 6.0 | 5.6 | 1.5 | 0.0 | 0.0 | 0.0 | 10.8 | 26.4 | 22.6 | 100.0 | 1.8 | <0.001 |
| Example 12 | 10.8 | 15.7 | 0.4 | 0.0 | 0.0 | 4.9 | 5.5 | 3.5 | 0.0 | 0.0 | 0.0 | 10.7 | 26.1 | 22.4 | 100.0 | 2.5 | <0.001 |
| Example 13 | 10.9 | 15.9 | 0.4 | 0.0 | 0.0 | 3.9 | 5.6 | 1.5 | 0.0 | 0.0 | 0.0 | 8.8 | 28.4 | 24.6 | 100.0 | 7.6 | 0.001 |
| Example 14 | 10.8 | 15.8 | 0.0 | 0.0 | 0.0 | 4.9 | 5.5 | 1.5 | 0.0 | 0.0 | 0.0 | 8.7 | 28.2 | 24.5 | 100.0 | 3.6 | 0.001 |
| Example 15 | 10.9 | 15.9 | 0.4 | 0.0 | 0.0 | 3.9 | 5.6 | 3.5 | 0.0 | 0.0 | 0.0 | 8.8 | 26.4 | 24.6 | 100.0 | 3.5 | 0.001 |
| Example 16 | 10.9 | 14.8 | 0.4 | 0.0 | 0.0 | 4.9 | 6.6 | 1.5 | 0.0 | 0.0 | 0.0 | 8.8 | 28.4 | 23.6 | 100.0 | 11.8 | 0.002 |
| Example 17 | 10.9 | 15.9 | 1.4 | 0.0 | 0.0 | 4.9 | 6.6 | 1.5 | 0.0 | 0.0 | 0.0 | 9.8 | 26.4 | 22.6 | 100.0 | 9.1 | <0.001 |
| Example 18 | 10.9 | 14.8 | 0.4 | 0.0 | 0.0 | 4.9 | 6.6 | 1.5 | 0.0 | 0.0 | 0.0 | 10.8 | 26.4 | 23.6 | 100.0 | 9.8 | <0.001 |
| Example 19 | 10.9 | 15.9 | 0.4 | 0.0 | 0.0 | 4.5 | 5.6 | 1.5 | 0.0 | 1.0 | 0.0 | 8.8 | 28.4 | 22.6 | 100.0 | 11.0 | 0.010 |
| Example 20 | 10.8 | 15.7 | 0.4 | 2.0 | 0.0 | 4.9 | 5.5 | 1.5 | 0.0 | 0.0 | 0.0 | 8.7 | 28.1 | 22.4 | 100.0 | 6.7 | <0.001 |
| Example 21 | 10.8 | 15.7 | 0.4 | 2.0 | 0.0 | 4.9 | 7.5 | 1.5 | 0.0 | 0.0 | 0.0 | 8.7 | 26.1 | 22.4 | 100.0 | 0.9 | <0.001 |
| Example 22 | 7.8 | 17.7 | 0.4 | 0.0 | 0.0 | 4.9 | 6.5 | 1.5 | 0.0 | 0.0 | 0.0 | 8.7 | 30.1 | 22.4 | 100.0 | 7.4 | 0.010 |
| Example 23 | 8.8 | 17.7 | 0.4 | 0.0 | 0.0 | 4.9 | 5.5 | 1.5 | 0.0 | 0.0 | 0.0 | 8.7 | 30.1 | 22.4 | 100.0 | 13.9 | 0.012 |
| Example 24 | 10.8 | 15.7 | 0.4 | 0.0 | 0.0 | 4.9 | 5.5 | 1.5 | 0.0 | 0.0 | 0.0 | 8.7 | 28.1 | 24.4 | 100.0 | 10.8 | 0.009 |
| Example 25 | 11.9 | 14.8 | 0.4 | 0.0 | 0.0 | 4.9 | 6.6 | 1.5 | 0.0 | 0.0 | 0.0 | 9.8 | 26.4 | 23.6 | 100.0 | 12.2 | 0.010 |
| Example 26 | 10.9 | 15.8 | 0.4 | 0.0 | 0.0 | 4.9 | 5.6 | 1.5 | 0.0 | 0.0 | 0.0 | 10.8 | 25.4 | 23.6 | 100.0 | 7.0 | 0.007 |
| Example 27 | 10.9 | 15.8 | 0.4 | 0.0 | 0.0 | 4.9 | 7.6 | 1.5 | 0.0 | 0.0 | 0.0 | 10.8 | 24.4 | 23.6 | 100.0 | 6.4 | 0.004 |
| Example 28 | 10.8 | 15.7 | 0.4 | 2.0 | 0.0 | 4.5 | 6.5 | 1.5 | 0.0 | 0.0 | 0.0 | 9.7 | 26.1 | 22.4 | 100.0 | 9.4 | 0.002 |
| Example 29 | 10.8 | 15.7 | 0.4 | 2.0 | 0.0 | 4.9 | 6.5 | 2.5 | 0.0 | 0.0 | 0.0 | 8.7 | 26.1 | 22.4 | 100.0 | 5.8 | 0.003 |
| Example 30 | 10.8 | 15.7 | 0.4 | 0.5 | 0.0 | 4.9 | 6.5 | 0.0 | 0.0 | 0.0 | 0.0 | 10.7 | 26.1 | 24.4 | 100.0 | 8.8 | 0.003 |
| Example 31 | 10.8 | 15.7 | 1.4 | 0.5 | 0.0 | 3.5 | 6.5 | 0.0 | 0.0 | 0.0 | 0.0 | 10.7 | 26.1 | 24.4 | 100.0 | 7.4 | 0.004 |
| Example 32 | 10.3 | 15.7 | 0.9 | 0.5 | 0.0 | 4.0 | 6.5 | 0.0 | 0.0 | 0.0 | 0.0 | 11.7 | 25.5 | 24.9 | 100.0 | 13.5 | 0.005 |
| Example 33 | 10.8 | 15.7 | 0.9 | 1.0 | 0.0 | 4.9 | 6.5 | 0.0 | 0.0 | 0.0 | 0.0 | 10.7 | 25.6 | 23.9 | 100.0 | 12.6 | 0.003 |
| Example 34 | 10.8 | 15.7 | 0.4 | 0.5 | 0.0 | 4.9 | 5.5 | 0.0 | 0.0 | 0.0 | 0.0 | 10.7 | 29.1 | 22.4 | 100.0 | 11.0 | 0.011 |
| Example 35 | 10.8 | 15.7 | 0.9 | 1.0 | 0.0 | 4.9 | 6.5 | 0.0 | 0.0 | 0.0 | 0.0 | 10.7 | 25.6 | 23.9 | 100.0 | 10.1 | 0.003 |
| Example 36 | 9.5 | 19.1 | 2.0 | 0.0 | 0.0 | 3.9 | 6.3 | 0.0 | 0.3 | 0.0 | 0.0 | 7.45 | 31.5 | 20.0 | 100.0 | 3.0 | 0.021 |
| Example 37 | 14.5 | 13.1 | 2.0 | 0.0 | 0.0 | 3.9 | 5.3 | 0.0 | 0.3 | 0.0 | 0.0 | 8.45 | 34.5 | 18.0 | 100.0 | 13.0 | 0.019 |
| Example 38 | 12 | 16.1 | 2.0 | 0.0 | 0.0 | 3.9 | 5.8 | 0.0 | 0.3 | 0.0 | 0.0 | 8.0 | 33.0 | 19.0 | 100.0 | 9.9 | 0.015 |
| Example 39 | 13.3 | 14.6 | 2.0 | 0.0 | 0.0 | 3.9 | 5.6 | 0.0 | 0.3 | 0.0 | 0.0 | 8.2 | 33.8 | 18.5 | 100.0 | 9.1 | 0.025 |

| | | | Refractive | | | Wave- | Young's | Specific | Abbe | Devitrification | | |
|---|---|---|---|---|---|---|---|---|---|---|---|---|
| | Parameter | Parameter | index | Transmittance | Transmittance | length | modulus | gravity | number | temperature | Optical | Defect |
| | A | B | n_{d} | τ₄₄₀ | τ₄₆₀ | λ₅(nm) | E(GPa) | d(g/cm³) | vd | (° C.) | evaluation | evaluation |
| Example 72 | 0.864 | 2.062 | 2.0423 | 0.822 | 0.871 | 371 | 121 | 5.22 | 24.71 | 1230 | x | x |
| Example 73 | 0.886 | 2.049 | 2.0514 | 0.796 | 0.853 | 372 | 125 | 4.97 | 24.12 | 1240 | x | x |
| Example 1 | 0.944 | 2.131 | 2.0384 | 0.915 | 0.942 | 367 | 133 | 5.31 | 27.68 | 1230 | ∘ | ∘ |
| Example 2 | 0.967 | 2.130 | 2.0346 | 0.915 | 0.944 | 369 | 133 | 5.26 | 27.78 | 1220 | ∘ | ∘ |
| Example 3 | 0.948 | 2.129 | 2.0440 | 0.907 | 0.938 | 370 | 133 | 5.29 | 27.36 | 1250 | ∘ | ∘ |
| Example 4 | 0.969 | 2.130 | 2.0391 | 0.917 | 0.941 | 367 | 133 | 5.34 | 27.83 | 1240 | ∘ | ∘ |
| Example 5 | 0.940 | 2.134 | 2.0382 | 0.919 | 0.945 | 368 | 133 | 5.30 | 27.72 | 1230 | ∘ | ∘ |
| Example 6 | 0.946 | 2.136 | 2.0420 | 0.919 | 0.946 | 368 | 135 | 5.30 | 27.67 | 1240 | ∘ | ∘ |
| Example 7 | 0.938 | 2.127 | 2.0323 | 0.913 | 0.942 | 369 | 133 | 5.26 | 27.83 | 1230 | ∘ | ∘ |
| Example 8 | 0.968 | 2.138 | 2.0381 | 0.925 | 0.950 | 368 | 134 | 5.30 | 27.85 | 1230 | ∘ | ∘ |
| Example 9 | 0.954 | 2.142 | 2.0409 | 0.930 | 0.952 | 367 | 147 | 5.31 | 27.84 | 1240 | ∘ | ∘ |
| Example 10 | 0.969 | 2.145 | 2.0361 | 0.940 | 0.958 | 365 | 146 | 5.34 | 28.31 | 1230 | ∘ | ∘ |
| Example 11 | 0.949 | 2.146 | 2.0357 | 0.940 | 0.959 | 365 | 148 | 5.36 | 28.32 | 1220 | ∘ | ∘ |
| Example 12 | 0.953 | 2.145 | 2.0354 | 0.940 | 0.958 | 365 | 147 | 5.32 | 28.18 | 1240 | ∘ | ∘ |
| Example 13 | 0.948 | 2.128 | 2.0386 | 0.910 | 0.940 | 368 | 133 | 5.29 | 27.88 | 1240 | ∘ | ∘ |
| Example 14 | 0.930 | 2.130 | 2.0391 | 0.912 | 0.941 | 367 | 133 | 5.34 | 27.97 | 1230 | ∘ | ∘ |
| Example 15 | 0.944 | 2.131 | 2.0326 | 0.927 | 0.946 | 364 | 132 | 5.32 | 28.35 | 1230 | ∘ | ∘ |
| Example 16 | 0.969 | 2.132 | 2.0480 | 0.910 | 0.938 | 368 | 133 | 5.34 | 27.47 | 1240 | ∘ | ∘ |
| Example 17 | 0.968 | 2.135 | 2.0392 | 0.922 | 0.946 | 367 | 134 | 5.31 | 27.98 | 1230 | ∘ | ∘ |
| Example 18 | 0.979 | 2.149 | 2.0452 | 0.930 | 0.956 | 367 | 134 | 5.36 | 27.89 | 1250 | ∘ | ∘ |
| Example 19 | 0.964 | 2.126 | 2.0394 | 0.909 | 0.937 | 369 | 134 | 5.33 | 27.60 | 1230 | ∘ | ∘ |
| Example 20 | 0.957 | 2.133 | 2.0329 | 0.923 | 0.948 | 367 | 131 | 5.29 | 27.88 | 1210 | ∘ | ∘ |
| Example 21 | 0.947 | 2.152 | 2.0378 | 0.943 | 0.964 | 366 | 130 | 5.30 | 27.72 | 1250 | ∘ | ∘ |
| Example 22 | 0.913 | 2.111 | 2.0513 | 0.876 | 0.915 | 371 | 135 | 5.27 | 26.93 | 1250 | ∘ | ∘ |
| Example 23 | 0.936 | 2.100 | 2.0432 | 0.866 | 0.909 | 371 | 134 | 5.26 | 27.28 | 1250 | ∘ | ∘ |
| Example 24 | 0.940 | 2.108 | 2.0386 | 0.886 | 0.919 | 367 | 133 | 5.34 | 28.03 | 1240 | ∘ | ∘ |
| Example 25 | 0.937 | 2.096 | 2.0407 | 0.876 | 0.906 | 367 | 133 | 5.34 | 27.98 | 1240 | ∘ | ∘ |
| Example 26 | 0.932 | 2.118 | 2.0385 | 0.897 | 0.930 | 366 | 133 | 5.34 | 28.22 | 1230 | ∘ | ∘ |
| Example 27 | 0.941 | 2.122 | 2.0406 | 0.909 | 0.932 | 365 | 133 | 5.35 | 28.16 | 1230 | ∘ | ∘ |
| Example 28 | 0.958 | 2.122 | 2.0336 | 0.911 | 0.936 | 365 | 131 | 5.31 | 28.04 | 1230 | ∘ | ∘ |
| Example 29 | 0.937 | 2.119 | 2.0326 | 0.908 | 0.934 | 365 | 132 | 5.31 | 28.03 | 1220 | ∘ | ∘ |
| Example 30 | 0.945 | 2.119 | 2.0399 | 0.901 | 0.930 | 365 | 133 | 5.35 | 28.18 | 1230 | ∘ | ∘ |
| Example 31 | 0.935 | 2.116 | 2.0386 | 0.898 | 0.927 | 365 | 133 | 5.31 | 28.20 | 1230 | ∘ | ∘ |
| Example 32 | 0.953 | 2.107 | 2.0408 | 0.886 | 0.917 | 365 | 133 | 5.34 | 28.29 | 1240 | ∘ | ∘ |
| Example 33 | 0.963 | 2.119 | 2.0406 | 0.900 | 0.930 | 367 | 133 | 5.32 | 27.93 | 1250 | ∘ | ∘ |
| Example 34 | 0.924 | 2.100 | 2.0436 | 0.869 | 0.908 | 370 | 134 | 5.29 | 27.49 | 1240 | ∘ | ∘ |
| Example 35 | 0.947 | 2.111 | 2.0369 | 0.897 | 0.923 | 364 | 132 | 5.35 | 28.32 | 1210 | ∘ | ∘ |
| Example 36 | 0.912 | 2.117 | 2.0410 | 0.897 | 0.927 | 369 | 126 | 5.08 | 26.44 | 1220 | ∘ | ∘ |
| Example 37 | 0.913 | 2.088 | 2.0542 | 0.848 | 0.890 | 369 | 125 | 5.08 | 25.57 | 1240 | ∘ | ∘ |
| Example 38 | 0.937 | 2.108 | 2.0413 | 0.887 | 0.918 | 368 | 126 | 5.08 | 26.09 | 1200 | ∘ | ∘ |
| Example 39 | 0.931 | 2.109 | 2.0443 | 0.886 | 0.917 | 367 | 125 | 5.08 | 25.88 | 1210 | ∘ | ∘ |

TABLE 2

| | Pt + |
|---|---|
| Composition (mol %) | Fe |

| | SiO₂ | B₂O₃ | Y₂O₃ | BaO | Bi₂O₃ | Gd₂O₃ | Nb₂O₅ | ZnO | WO₃ | Ta₂O₅ | P₂O₅ | ZrO₂ | TiO₂ | La₂O₃ | Total | (ppm) | Ti³⁺/Ti |
|---|---|---|---|---|---|---|---|---|---|---|---|---|---|---|---|---|---|
| Example 40 | 12.6 | 15.4 | 2.0 | 0.0 | 0.0 | 3.3 | 5.7 | 0.0 | 0.3 | 0.0 | 0.0 | 8.1 | 33.4 | 19.4 | 100.0 | 11.5 | 0.001 |
| Example 41 | 12.9 | 15.0 | 2.0 | 0.0 | 0.0 | 3.6 | 5.6 | 0.0 | 0.3 | 0.0 | 0.0 | 8.1 | 33.6 | 18.9 | 100.0 | 8.8 | 0.023 |
| Example 42 | 12.8 | 15.2 | 2.0 | 0.0 | 0.0 | 3.5 | 5.6 | 0.0 | 0.3 | 0.0 | 0.0 | 8.1 | 33.5 | 19.1 | 100.0 | 13.0 | 0.019 |
| Example 43 | 10.5 | 17.0 | 1.4 | 0.0 | 0.0 | 3.0 | 6.3 | 0.0 | 0.3 | 0.0 | 0.0 | 7.6 | 34.0 | 20.0 | 100.0 | 13.0 | 0.019 |
| Example 44 | 11.6 | 16.1 | 1.7 | 0.0 | 0.0 | 3.2 | 6.0 | 0.0 | 0.3 | 0.0 | 0.0 | 7.8 | 33.7 | 19.6 | 100.0 | 13.4 | 0.025 |
| Example 45 | 11.1 | 16.5 | 1.6 | 0.0 | 0.0 | 3.1 | 6.1 | 0.0 | 0.3 | 0.0 | 0.0 | 7.7 | 33.9 | 19.8 | 100.0 | 7.5 | 0.000 |
| Example 46 | 11.4 | 16.3 | 1.6 | 0.0 | 0.0 | 3.2 | 6.1 | 0.0 | 0.3 | 0.0 | 0.0 | 7.8 | 33.8 | 19.7 | 100.0 | 13.7 | 0.018 |
| Example 47 | 9.5 | 19.1 | 2.0 | 0.0 | 0.0 | 3.9 | 5.3 | 0.0 | 0.1 | 0.0 | 0.0 | 7.5 | 31.5 | 21.2 | 100.0 | 13.3 | 0.009 |
| Example 48 | 10.4 | 17.7 | 1.8 | 0.0 | 0.0 | 3.5 | 5.7 | 0.0 | 0.2 | 0.0 | 0.0 | 7.6 | 32.7 | 20.4 | 100.0 | 7.7 | 0.017 |
| Example 49 | 10.0 | 18.4 | 1.9 | 0.0 | 0.0 | 3.7 | 5.5 | 0.0 | 0.1 | 0.0 | 0.0 | 7.5 | 32.1 | 20.8 | 100.0 | 6.4 | 0.029 |
| Example 50 | 10.2 | 18.1 | 1.9 | 0.0 | 0.0 | 3.6 | 5.6 | 0.0 | 0.2 | 0.0 | 0.0 | 7.6 | 32.4 | 20.6 | 100.0 | 10.6 | 0.016 |
| Example 51 | 14.5 | 13.1 | 2.0 | 0.0 | 0.0 | 3.9 | 5.3 | 0.0 | 0.3 | 0.0 | 0.0 | 8.5 | 34.5 | 18.0 | 100.0 | 10.3 | 0.006 |
| Example 52 | 7.6 | 19.6 | 2.2 | 0.0 | 0.0 | 2.1 | 7.3 | 0.1 | 0.0 | 0.5 | 0.0 | 8.0 | 32.3 | 20.4 | 100.0 | 9.2 | 0.025 |
| Example 53 | 11.1 | 16.4 | 2.1 | 0.0 | 0.0 | 3.0 | 6.3 | 0.1 | 0.1 | 0.2 | 0.0 | 8.2 | 33.4 | 19.2 | 100.0 | 10.8 | 0.004 |
| Example 54 | 9.3 | 18.0 | 2.1 | 0.0 | 0.0 | 2.5 | 6.8 | 0.1 | 0.1 | 0.4 | 0.0 | 8.1 | 32.9 | 19.8 | 100.0 | 9.1 | 0.014 |
| Example 55 | 10.2 | 17.2 | 2.1 | 0.0 | 0.0 | 2.8 | 6.5 | 0.1 | 0.1 | 0.3 | 0.0 | 8.1 | 33.1 | 19.5 | 100.0 | 3.1 | 0.005 |
| Example 56 | 14.3 | 13.1 | 2.0 | 0.0 | 0.1 | 3.9 | 5.4 | 0.0 | 0.1 | 0.0 | 0.0 | 8.5 | 34.5 | 18.0 | 100.0 | 12.7 | 0.009 |
| Example 57 | 12.2 | 15.1 | 2.1 | 0.0 | 0.0 | 3.4 | 5.9 | 0.0 | 0.1 | 0.2 | 0.0 | 8.3 | 33.8 | 18.8 | 100.0 | 7.8 | 0.003 |
| Example 58 | 13.2 | 14.1 | 2.0 | 0.0 | 0.1 | 3.6 | 5.7 | 0.0 | 0.1 | 0.1 | 0.0 | 8.4 | 34.2 | 18.4 | 100.0 | 9.2 | 0.011 |
| Example 59 | 12.7 | 14.6 | 2.1 | 0.0 | 0.1 | 3.5 | 5.8 | 0.0 | 0.1 | 0.1 | 0.0 | 8.4 | 34.0 | 18.6 | 100.0 | 10.1 | 0.007 |
| Example 60 | 7.5 | 19.5 | 2.1 | 0.0 | 0.0 | 2.2 | 8.0 | 0.1 | 0.0 | 0.4 | 0.0 | 7.9 | 32.1 | 20.3 | 100.0 | 10.8 | 0.022 |
| Example 61 | 7.9 | 19.6 | 1.1 | 0.2 | 0.0 | 2.4 | 7.9 | 0.3 | 0.0 | 0.4 | 0.1 | 7.9 | 32.0 | 20.3 | 100.0 | 11.6 | 0.010 |
| Example 62 | 7.7 | 19.4 | 1.4 | 0.1 | 0.0 | 2.4 | 8.8 | 0.1 | 0.0 | 0.2 | 0.1 | 7.8 | 31.7 | 20.2 | 100.0 | 5.6 | 0.022 |
| Example 63 | 7.7 | 19.4 | 1.3 | 0.1 | 0.0 | 2.4 | 9.6 | 0.1 | 0.1 | 0.2 | 0.1 | 7.7 | 31.4 | 20.1 | 100.0 | 9.7 | 0.011 |
| Example 64 | 8.5 | 20.1 | 3.0 | 0.0 | 0.0 | 2.9 | 5.3 | 0.0 | 1.3 | 0.0 | 0.0 | 6.5 | 32.5 | 20.0 | 100.0 | 7.7 | 0.012 |
| Example 65 | 10.5 | 18.1 | 1.0 | 0.0 | 0.0 | 4.9 | 7.3 | 0.0 | 0.3 | 0.0 | 0.0 | 8.5 | 30.5 | 19.0 | 100.0 | 3.1 | 0.028 |
| Example 66 | 12.5 | 15.6 | 1.5 | 0.0 | 0.0 | 4.4 | 6.3 | 0.0 | 0.3 | 0.0 | 0.0 | 8.5 | 32.5 | 18.5 | 100.0 | 2.3 | <0.001 |
| Example 67 | 13.5 | 14.1 | 1.0 | 0.0 | 0.0 | 4.9 | 4.3 | 0.0 | 1.3 | 0.0 | 0.0 | 7.5 | 35.5 | 18.0 | 100.0 | 9.5 | 0.003 |
| Example 68 | 15.5 | 12.1 | 0.0 | 0.0 | 0.0 | 2.9 | 6.3 | 0.0 | 0.3 | 0.0 | 0.0 | 9.5 | 33.5 | 20.0 | 100.0 | 10.4 | 0.030 |
| Example 69 | 12.5 | 15.6 | 1.0 | 0.0 | 0.0 | 3.4 | 6.3 | 0.0 | 0.3 | 0.0 | 0.0 | 8.5 | 32.5 | 20.0 | 100.0 | 6.1 | 0.021 |
| Example 70 | 9.5 | 19.1 | 2.0 | 0.0 | 0.0 | 3.9 | 5.3 | 0.0 | 0.3 | 0.0 | 0.0 | 8.5 | 31.5 | 20.0 | 100.0 | 8.2 | 0.002 |
| Example 71 | 9.5 | 19.1 | 1.0 | 0.0 | 0.0 | 4.9 | 5.3 | 0.0 | 0.3 | 0.0 | 0.0 | 8.5 | 31.5 | 20.0 | 100.0 | 8.4 | 0.009 |

| | | | Refractive | | | Wave- | Young's | Specific | Abbe | Devitrification | | |
|---|---|---|---|---|---|---|---|---|---|---|---|---|
| | Parameter | Parameter | index | Transmittance | Transmittance | length | modulus | gravity | number | temperature | Optical | Defect |
| | A | B | n_{d} | τ₄₄₀ | τ₄₆₀ | λ₅(nm) | E(GPa) | d(g/cm³) | vd | (° C.) | evaluation | evaluation |
| Example 40 | 0.939 | 2.103 | 2.0426 | 0.881 | 0.912 | 369 | 124 | 5.07 | 26.00 | 1200 | ∘ | ∘ |
| Example 41 | 0.927 | 2.112 | 2.0435 | 0.884 | 0.921 | 369 | 124 | 5.07 | 25.94 | 1210 | ∘ | ∘ |
| Example 42 | 0.947 | 2.113 | 2.0431 | 0.883 | 0.921 | 367 | 124 | 5.07 | 25.97 | 1200 | ∘ | ∘ |
| Example 43 | 0.933 | 2.102 | 2.0475 | 0.868 | 0.909 | 369 | 122 | 5.05 | 25.66 | 1200 | ∘ | ∘ |
| Example 44 | 0.942 | 2.105 | 2.0453 | 0.875 | 0.913 | 370 | 123 | 5.06 | 25.82 | 1210 | ∘ | ∘ |
| Example 45 | 0.909 | 2.097 | 2.0464 | 0.872 | 0.904 | 367 | 122 | 5.06 | 25.74 | 1240 | ∘ | ∘ |
| Example 46 | 0.942 | 2.099 | 2.0458 | 0.873 | 0.906 | 368 | 123 | 5.06 | 25.78 | 1220 | ∘ | ∘ |
| Example 47 | 0.957 | 2.114 | 2.0335 | 0.891 | 0.928 | 369 | 128 | 5.12 | 27.00 | 1220 | ∘ | ∘ |
| Example 48 | 0.920 | 2.102 | 2.0397 | 0.882 | 0.913 | 367 | 125 | 5.09 | 26.39 | 1200 | ∘ | ∘ |
| Example 49 | 0.918 | 2.112 | 2.0366 | 0.886 | 0.925 | 367 | 126 | 5.10 | 26.70 | 1220 | ∘ | ∘ |
| Example 50 | 0.937 | 2.107 | 2.0381 | 0.884 | 0.918 | 367 | 126 | 5.10 | 26.54 | 1230 | ∘ | ∘ |
| Example 51 | 0.936 | 2.111 | 2.0473 | 0.885 | 0.918 | 367 | 125 | 5.08 | 25.68 | 1200 | ∘ | ∘ |
| Example 52 | 0.916 | 2.108 | 2.0500 | 0.870 | 0.913 | 369 | 122 | 5.06 | 25.86 | 1240 | ∘ | ∘ |
| Example 53 | 0.931 | 2.104 | 2.0486 | 0.877 | 0.910 | 367 | 124 | 5.07 | 25.77 | 1250 | ∘ | ∘ |
| Example 54 | 0.919 | 2.100 | 2.0493 | 0.874 | 0.906 | 369 | 123 | 5.06 | 25.82 | 1200 | ∘ | ∘ |
| Example 55 | 0.941 | 2.109 | 2.0490 | 0.876 | 0.915 | 368 | 123 | 5.06 | 25.79 | 1240 | ∘ | ∘ |
| Example 56 | 0.928 | 2.103 | 2.0520 | 0.864 | 0.906 | 368 | 125 | 5.10 | 25.62 | 1220 | ∘ | ∘ |
| Example 57 | 0.909 | 2.100 | 2.0505 | 0.870 | 0.905 | 368 | 124 | 5.08 | 25.71 | 1250 | ∘ | ∘ |
| Example 58 | 0.913 | 2.106 | 2.0512 | 0.867 | 0.910 | 370 | 125 | 5.09 | 25.66 | 1240 | ∘ | ∘ |
| Example 59 | 0.919 | 2.106 | 2.0509 | 0.869 | 0.911 | 367 | 124 | 5.09 | 25.69 | 1220 | ∘ | ∘ |
| Example 60 | 0.924 | 2.104 | 2.0559 | 0.870 | 0.905 | 370 | 121 | 5.06 | 25.67 | 1250 | ∘ | ∘ |
| Example 61 | 0.928 | 2.100 | 2.0522 | 0.870 | 0.903 | 368 | 122 | 5.05 | 25.68 | 1200 | ∘ | ∘ |
| Example 62 | 0.909 | 2.116 | 2.0568 | 0.881 | 0.917 | 369 | 120 | 5.05 | 25.46 | 1240 | ∘ | ∘ |
| Example 63 | 0.918 | 2.109 | 2.0585 | 0.870 | 0.909 | 369 | 118 | 5.05 | 25.26 | 1200 | ∘ | ∘ |
| Example 64 | 0.909 | 2.083 | 2.0101 | 0.871 | 0.911 | 370 | 122 | 4.97 | 26.29 | 1210 | ∘ | ∘ |
| Example 65 | 0.915 | 2.116 | 2.0404 | 0.899 | 0.926 | 366 | 130 | 5.12 | 26.28 | 1220 | ∘ | ∘ |
| Example 66 | 0.903 | 2.119 | 2.0439 | 0.892 | 0.927 | 368 | 128 | 5.10 | 25.98 | 1220 | ∘ | ∘ |
| Example 67 | 0.925 | 2.094 | 2.0236 | 0.877 | 0.914 | 369 | 127 | 5.05 | 25.46 | 1230 | ∘ | ∘ |
| Example 68 | 0.924 | 2.107 | 2.0523 | 0.872 | 0.911 | 368 | 122 | 5.09 | 25.54 | 1230 | ∘ | ∘ |
| Example 69 | 0.911 | 2.103 | 2.0439 | 0.881 | 0.912 | 367 | 124 | 5.09 | 26.02 | 1230 | ∘ | ∘ |
| Example 70 | 0.944 | 2.122 | 2.03811 | 0.903 | 0.934 | 370 | 135 | 5.09 | 26.66 | 1190 | ∘ | ∘ |
| Example 71 | 0.957 | 2.136 | 2.03912 | 0.915 | 0.947 | 370 | 136 | 5.14 | 26.65 | 1190 | ∘ | ∘ |

In Example 1, glasses having a composition described in Table 1 and thicknesses of 10 mm and 1 mm were manufactured. Specifically, raw materials having the composition presented in Table 1 were uniformly mixed and melted in a platinum crucible at 1300° C. for two hours to obtain a uniform molten glass. Next, the molten glass was poured into a carbon mold having a size of length×width×height=length 60 mm×width 50 mm×height 30 mm. Thereafter, the molten glass was held at 660° C. for one hour, and then cooled to room temperature at a temperature falling rate of about 1° C./min to obtain a glass block. Next, the glass block was cut into a size of 30 mm (length)×30 mm (width) using a cutting machine (small cutting machine manufactured by MARUTO INSTRUMENT CO., LTD.), and the cut glass block was subjected to plate thickness adjustment and surface polishing using a grinding machine (SGM-6301 manufactured by Shuwa Industry Co., Ltd.) and a single-side polishing machine (EJ-380IN manufactured by Engis Japan Corporation) to manufacture glasses having a size of 30 mm (length)×30 mm (width) and plate thicknesses of 10 mm and 1 mm.

The total content of Pt and Fe in the glass of Example 1 was measured. As a measurement method, the method described in the above embodiment was used.

A ratio (Ti³⁺/Ti) of the glass of Example 1 was measured. As a measurement method, the method described in the above embodiment was used.

The refractive index n_{d}, the transmittance τ₄₄₀, the transmittance τ₄₆₀, the wavelength λ₅, the Young's modulus E, the specific gravity d, the Abbe number v_{d}, and the devitrification temperature of the glass of Example 1 were measured. As a measurement method, the method described in the above embodiment was used.

Measurement results are presented in Table 1.

### Examples 2 to 73

In Examples 2 to 73, glasses were manufactured in a similar manner to Example 1 except that the composition was changed to those presented in Table 1 or 2. Measurement results of the glasses of Examples are presented in Table 1.

### Evaluation

For the glasses of Examples, evaluation of optical characteristics and evaluation of defect deposition were performed.

In the evaluation of the optical characteristics, a case where the transmittance τ₄₄₀ was 0.840 or more and the refractive index n_{d} was 2.0100 or more was evaluated as ∘, and a case where at least one of them was not satisfied was evaluated as ×.

In the evaluation of defect deposition, a case where no defect was visually deposited was evaluated as ∘, and a case where a defect was deposited was evaluated as ×.

As presented in Table 1, in Examples 72 and 73 as Comparative Examples, at least one of evaluations of the optical characteristics and the defect deposition is ×, and it can be seen that it is not possible to suppress the deposition of defects while achieving a high refractive index and a high transmittance. In Examples 1 to 71 as Working Examples, both evaluations of the optical characteristics and the defect deposition are ∘, and it can be seen that the deposition of defects can be suppressed while achieving a high refractive index and a high transmittance.

According to the present invention, it is possible to suppress deposition of defects while achieving a high refractive index and a high transmittance.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A glass comprising La₂O₃ and B₂O₃,
having a refractive index n_{d} of 2.0100 or more, having a total content of Bi₂O₃ and B₂O₃ of less than 80% in terms of oxide-based mol %,
having a total content of Pt and Fe of 0.5 ppm or more and 15.0 ppm or less in terms of a mass ratio, and
having a parameter A defined by formula (1) of 0.870 or more:
$$A = {τ}_{440} + 0.005 \times ( Pt + Fe ) \qquad ( 1 )$$
wherein
τ₄₄₀ is an internal transmittance with respect to light having a wavelength of 440 nm when a thickness is converted to 10 mm, and
(Pt+Fe) is a total content (ppm) of Pt and Fe in terms of a mass ratio.

2. The glass according to claim 1, wherein a parameter B defined by formula (2) is 2.075 or more:
$$B = {τ}_{440} + 0.583 \times {n}_{d} \qquad ( 2 )$$
wherein τ₄₆₀ is an internal transmittance with respect to light having a wavelength of 460 nm when a thickness is converted to 10 mm.

3. The glass according to claim 1, having a devitrification temperature of 1250° C. or lower.

4. The glass according to claim 1, having a Young's modulus of 90 GPa or more.

5. The glass according to claim 1, wherein a ratio of a content of trivalent Ti to a total content of Ti in terms of a mass ratio is less than 0.100.

6. The glass according to claim 1, containing no Sb.

7. The glass according to claim 1, comprising, in terms of oxide-based mol %,
SiO₂: 0% or more and 20.0% or less,
B₂O₃: 0% or more and 30.0% or less,
Y₂O₃: 0% or more and 10.0% or less,
BaO: 0% or more and 10.0% or less,
Bi₂O₃: 0% or more and 30.0% or less,
Gd₂O₃: 0% or more and 10.0% or less,
Nb₂O₅: 0% or more and 10.0% or less,
ZnO: 0% or more and 20.0% or less,
WO₃: 0% or more and less than 30.0%,
Ta₂O₅: 0% or more and 10.0% or less,
P₂O₅: 0% or more and 30.0% or less,
ZrO₂: 0% or more and 15.0% or less,
TiO₂: 0% or more and 40.0% or less, and
La₂O₃: 0% or more and 40.0% or less.

8. The glass according to claim 1, having a specific gravity of 6.20 g/cm³ or less.

9. The glass according to claim 1, which is used as a light guide plate.

10. A method for manufacturing a glass, comprising:
heating raw materials at 950° C. or higher and 1600° C. or lower to dissolve the raw materials; and
cooling the dissolved raw materials to obtain the glass according to claim 1.
